(19) United States
(12) Patent Application Publication
(10) Pub. No.: US 2011/0315845 A1
(43) Pub. Date: Dec. 29, 2011

(54) Holding and Attachment Device

(76) Inventor: Burrell Clawson, Balboa Island, CA (US)

(21) Appl. No.: 12/824,164

(22) Filed: Jun. 26, 2010

(51) Int. Cl. F16M 13/00

(52) U.S. Cl. 248/316.5

(57) ABSTRACT

A holding device is configured to hold an item. In an embodiment, the device comprises a base member and a first holding member pivotably attached to a first side of the base member so as to be rotatable relative to the base member. A second holding member is pivotably attached to a second side of the base member opposite the first side so as to be rotatable relative to the base member, wherein the first and second holding members can be rotated toward one another. A latch assembly is coupled to the first and second holding members, wherein the latch assembly latches as the first and second holding members are rotated toward one another so as to secure the holding device in closed state.

### BACKGROUND

The present disclosure relates to devices for holding and supporting items.

It is often desirable to hold and/or secure items such as elongated wires, cables, cords, and loose cord connectors, etc. in a compact and efficient manner. For example, a home office or entertainment area typically has a multitude of power cords, video cables, sound cables, etc. When left unbundled or unsecured, the multitude of cables can be unsafe and unwieldy, as well as unattractive to the eye.

There currently exists a variety of holding devices configured to hold and secure such elongated items. Unfortunately, existing holding devices are typically configured to hold a specific type of item and are not easily used with other types of items. As a result, a user in need of holding devices for various items must acquire a variety of separate holding devices each configured for the specific item to be held. This can be costly and cumbersome.

Moreover, existing holding device are usually configured to be locked in the holding state and then unlocked when it is desired to release the item being held. While it can be convenient to be able to lock the holding device in a particular state, existing device make it difficult to transition between the locked and unlocked states. This is another drawback of existing holding devices.

In view of the foregoing, there is a need for improved devices for holding items, particularly elongated items such as cables and wires.

### SUMMARY

Disclosed are devices and methods for holding and/or securing items, including elongated items such as wires and cables.

In one aspect, there is disclosed a holding device for holding an item, comprising: a base member; a first holding member pivotably attached to a first side of the base member so as to be rotatable relative to the base member; a second holding member pivotably attached to a second side of the base member opposite the first side so as to be rotatable relative to the base member, wherein the first and second holding members can be rotated toward one another; and a latch assembly coupled to the first and second holding members, wherein the latch assembly latches as the first and second holding members are rotated toward one another so as to secure the holding device in closed state with the first holding member and second holding member attached to one another, and wherein the base member, first holding member, and second holding member collectively form a triangular shape when the device is in the closed state.

In another aspect, there is disclosed a holding device, comprising: a base member; a first hinge on one side of the base member and a second hinge on an opposite side of the base member; and a holding member on each of the hinges, each of the holding members having a latching member positioned on edge of the holding member opposite the location of the hinge, wherein each holding member rotates about its respective hinge toward the other holding member, and wherein the latching members latch to secure the edges of the holding members to one another such that the base member, first holding member, and second holding member collectively form a triangular shape when the latching members are latched

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 shows a perspective view of a first embodiment of a holding device that is adapted to hold an item.

FIG. 2 shows the holding device in a closed state wherein the device is releasably locked in a triangular configuration.

FIG. 3 shows the holding device in a flattened state.

FIGS. 4A-4C show how the holding device transitions from the open state to the closed state.

FIGS. 5A-5C show the holding device holding an elongated item in various orientations.

FIG. 6 shows an embodiment of the holding device wherein the latch assembly is a ball latch configuration

FIG. 7 shows another embodiment of a holding device where the latched device snaps around a solid rod creating sufficient friction to hold the device in position on a pole.

FIG. 8 shows another embodiment of a holding device.

FIG. 9 shows an embodiment of a holding device that is formed of a plurality of holding members that can be removably secured to one another in a variety of closed configurations.

FIG. 10 shows the holding device of FIG. 9 in cross-section.

FIG. 11 shows another embodiment of a holding device.

FIGS. 12-14 show examples of the holding device holding various items.

FIG. 15 shows an embodiment where a releasable adhesive is used as a wire holding device.

### DETAILED DESCRIPTION

Before the present subject matter is further described, it is to be understood that this subject matter described herein is not limited to particular embodiments described, as such may of course vary. It is also to be understood that the terminology used herein is for the purpose of describing particular embodiments only, and is not intended to be limiting. Unless defined otherwise, all technical terms used herein have the same meaning as commonly understood by one skilled in the art to which this subject matter belongs.

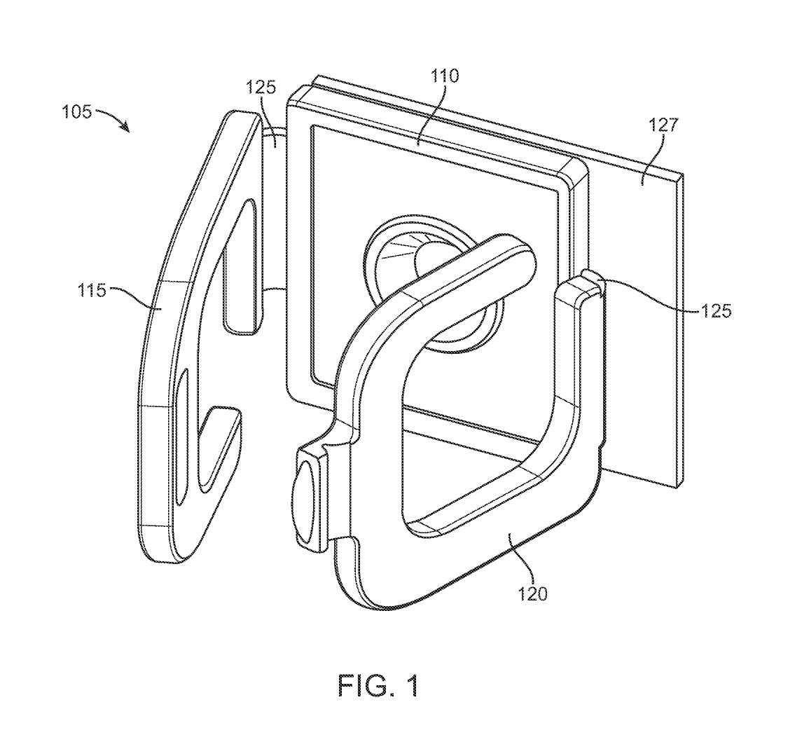

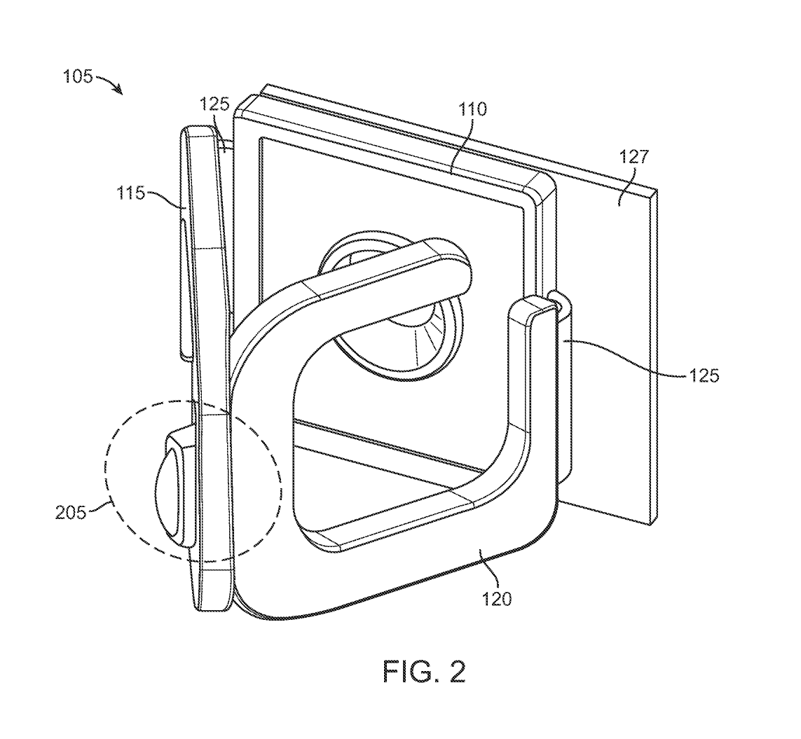

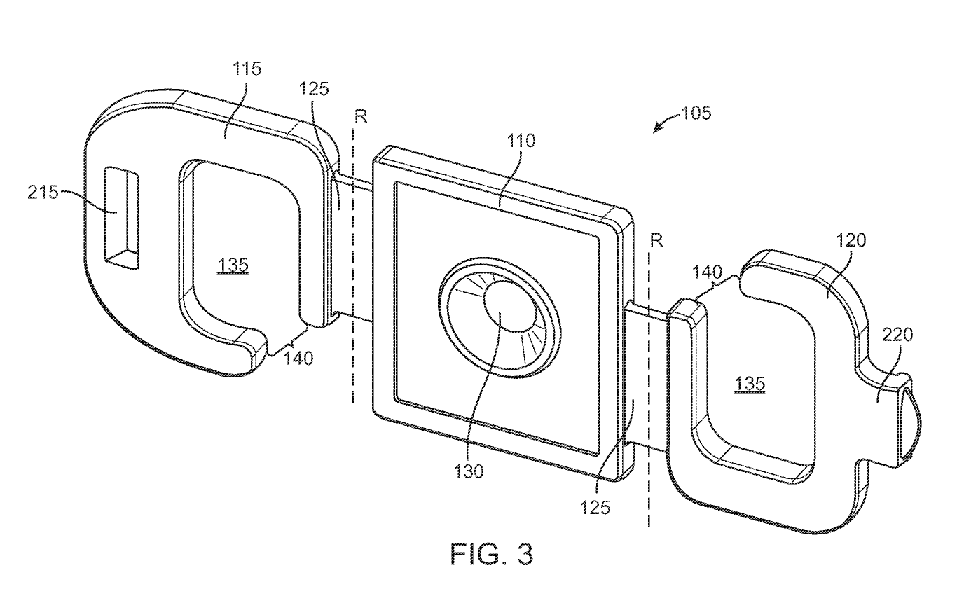

FIG. 1 shows a perspective view of a first embodiment of a holding device 105 that is adapted to hold an item. FIG. 1 shows the device 105 in an open state. FIG. 2 shows the device in a closed state wherein the device is releasably locked in a stable, triangular configuration, as described in more detail below. FIG. 3 shows the device 105 in a flattened state. The device 105 can be transitioned between the various states shown in FIGS. 1-3 as well as to intermediate states. The device 105 is configured to hold a variety of different items of various shapes and sizes, such as items of elongated shape, some of which are described herein.

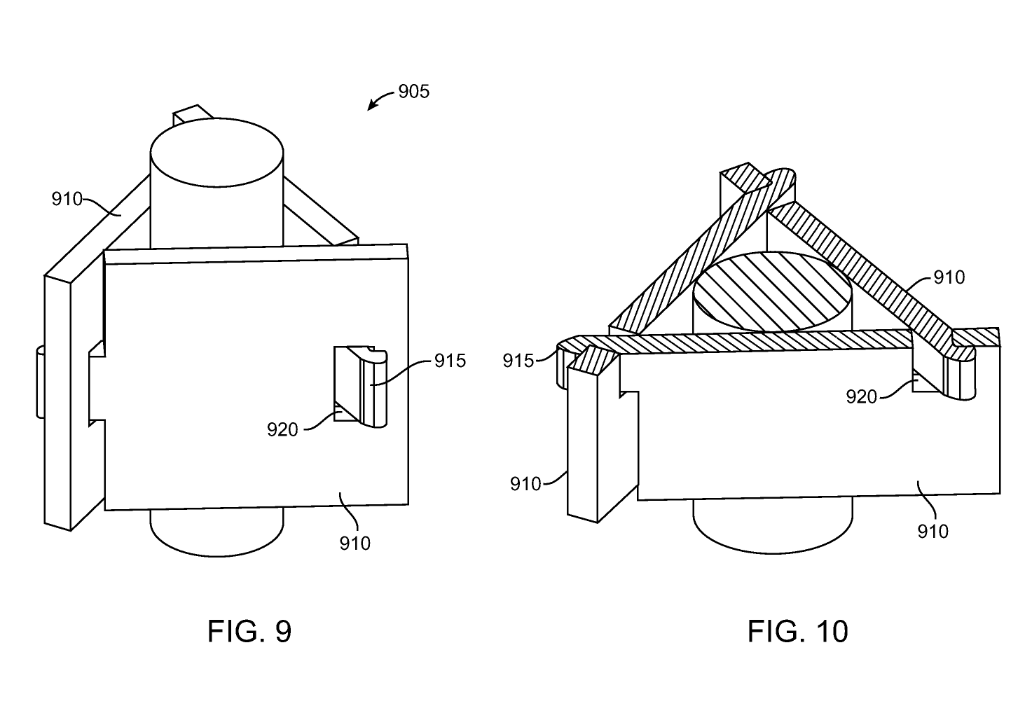

With reference to FIGS. 1 through 3, the device 105 generally includes a plurality of planar members that are hingedly coupled to one another, as described more fully below. The device 105 includes a base member 110 having a generally planar structure. The base member is positioned between and hingedly attached to a pair of holding members 115 and 120 that also have generally planar structures. The holding members 115 and 120 may be removably secured to one another using a latch assembly 205, as shown in FIG. 2 and described in detail below. A hinge 125 couples each of the holding members 115 and 120 to the base member 110 in a manner that permits the holding members 115 and 120 to rotate about respective axes of rotation R (FIG. 3) relative to the base member 110. In this manner, the members 110, 115, and 120 can be arranged in a variety of spatial configurations, including the open configuration of FIG. 1, the closed, triangular configuration of FIG. 2, and the flat configuration of FIG. 3, as well as configurations intermediate of those shown in FIGS. 1-3. In other words, the device 105 has a full range of motion between the various states shown in FIGS. 1-3. When in the triangular configuration (and square configurations in FIGS. 9 and 10), each holding member 910 is oriented at an angle relative to an adjacent holding member 910. In an embodiment, the angle is in the range of about 60 degrees to about 80 degrees, although the angles can vary outside this range. In another embodiment, the range is about 50 degrees to about 90 degrees.

The base member 110 is generally flat in shape such that it may be positioned against and secured to a flat, planar surface such as a wall using double-stick adhesive 127, which can adhere to a flat surface or wall. In this regard, a mounting hole 130 extends through the base member 110 to permit mounting means, such as a bolt, rivet, tack or a screw, to be inserted through the base member 110 for attaching to a surface. Alternatively, a mounting hole 130 need not be present and other mounting means, such as adhesive, may be used. The base member 110 can also have a contoured shape or a curviplanar shape to permit the base member 110 to be mounted on a contoured or curved surface.

With reference still to FIGS. 1-3, the holding members 115 and 120 generally each have a flat or planar shape and structure that lie within a single plane, although the shape can also be contoured. In the embodiment of FIG. 1, each of the holding members 115 and 120 has a hook-shape, such as generally “C”-shaped outer wall, that forms a central opening 135 through which an item to be held may be positioned. The opening 135 can be partially encircled such that an access space 140 is formed (FIG. 3), or the opening can be completely encircled or a closed loop without an access space. Also, a user can vary the size of the access space 140 as needed by simply trimming the holding members 115 and/or 120 as desired. It should be appreciated that the size of the holding members 115 and 120 can vary to accommodate items of different sizes. Moreover, the shape of the holding members can also vary from what is shown to accommodate items of different shapes, contours, sizes, etc.

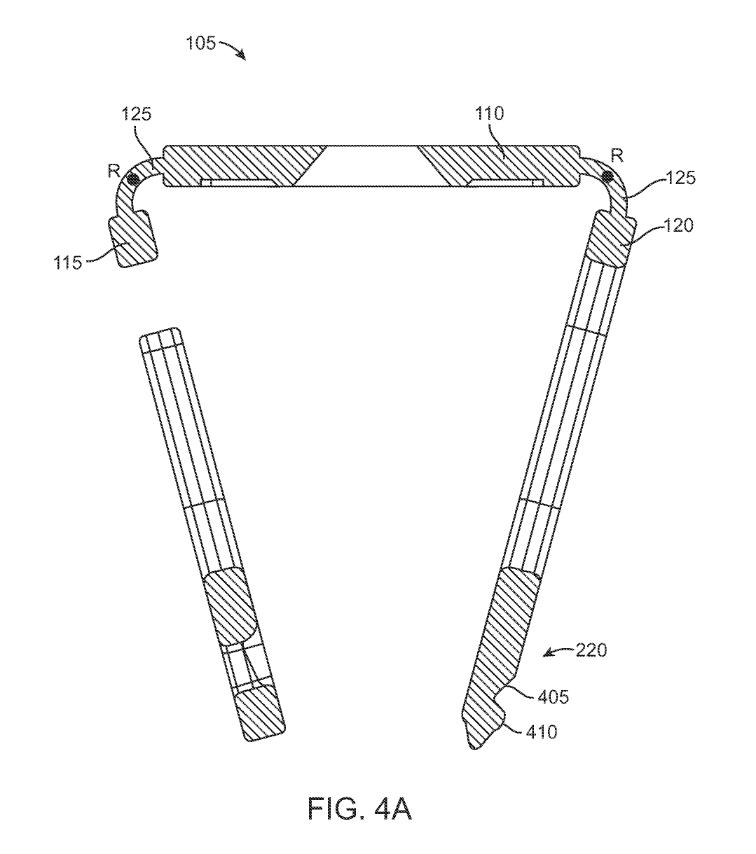

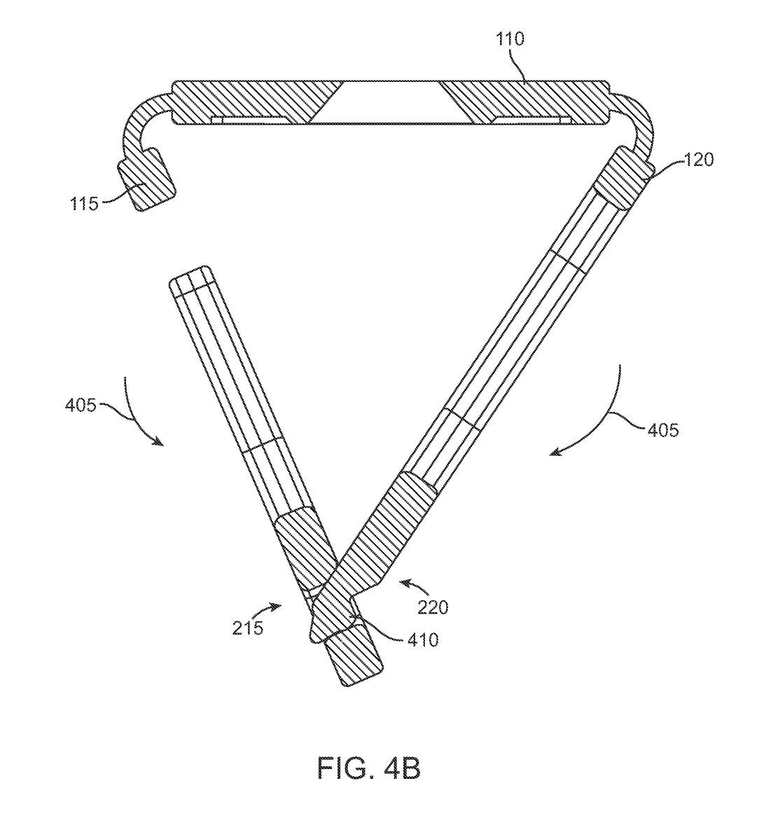

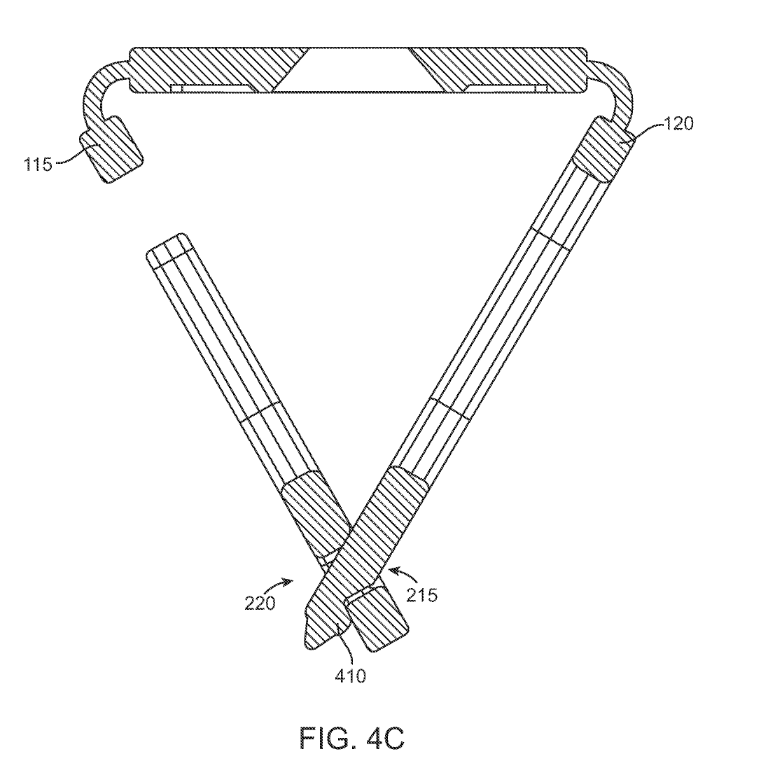

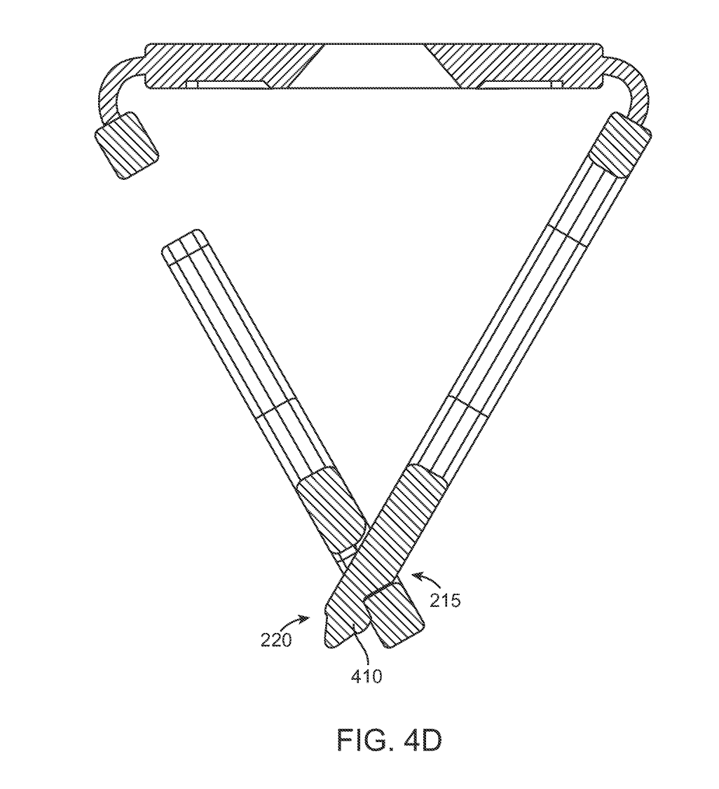

With reference to FIGS. 2 and 3, the latch assembly 205 is formed of a first latch member 215 on an outer edge of the holding member 115 and a second latch member 220 on the outer edge of the holding member 120 opposite the locations of the hinges 125. The latch members 215 and 220 removably attach to one another such that the outer edges of the holding members 115 and 120 can be removably secured to one another in the manner shown in FIG. 2. In an embodiment, the first latch member 215 is a female member formed of an opening that is sized to receive the second latch member 220, which inserts into the first latch member 215. For example, as shown in FIG. 4A, the second latch member 220 is a protrusion having a sloped surface 405 that extends toward a shoulder 410 that forms a raised surface relative to the sloped surface 405. In this manner, the shoulder 410 and sloped surface 405 collectively form a groove that acts as a seat for latching the first latch member 215 to the second latch member 220.

FIGS. 4A-4C show how the device 105 transitions from the open state to the closed state and releasably locks in the closed state using the latch assembly 205. FIGS. 4A-4C show cross-sectional views of the device looking in line with the axes of rotation R. With reference to FIG. 4A, in the open state the two holding members 115 and 120 are initially unlatched such that the two holding members 115 and 120 are oriented at an angle relative to the base member 110. With reference now to FIG. 4B, the two holding members 115 and 120 can be rotated toward one another about the hinges 125, as represented by the arrows 405. As the two holding members 115 and 120 rotate toward one another, the second latch member 220 starts to couple to the first latch member 215. That is, the protrusion of the second latch member 220 begins to insert through the opening of the first latch member 215 such that the shoulder 410 slides against the outer wall of the opening of the first latch member 215.

Next, as shown in FIG. 4C, the two holding members 115 and 120 continue to rotate toward one another until the protrusion of the second latch member 220 passes through the opening of the first latch member 215. The shoulder 410 eventually passes entirely through the opening such that the sloped surface 405 faces the outer wall of the opening, as shown in FIG. 4C. Finally, as shown in FIG. 4D, the shoulder 410 abuts the outer wall of the opening and the second latch member 220 is fully latched within the first latch member 215. That is, the wall of the opening of the first latch member 215 sits within the groove formed by the shoulder 410 and raised sloped surface of the protrusion of the second latch member 220. In this manner, the shoulder 410 forms a locked engagement with the outer wall of the opening of the first latch member 215. In an embodiment, the angle between the two holding members is in the range of about 50 degrees to about 100 degrees although the angle can vary outside that range.

The angled shape of the protrusion of the second latch member 220 facilitates an easy insertion of the second latch member 220 into the opening of the first latch member 215 as the holding members 115 and 120 rotate toward one another. The shoulder 410 on the second latch member 220 desirably has a beveled shape that slides easily into the opening of the first latch member 215. However, once the latch members are fully coupled to one another, the raised portion of the shoulder 410 locks against the inner wall of the first latch member 215 to prevent inadvertent releasing of the latch members. The latch assembly is configured to stay latched in response to various levels of force, such as moderate tugs, and can also release upon encountering a force above a threshold level. The user can unlatch the device by repositioning the latch members relative to one another and pulling apart. In an embodiment, the user pushes down on one of the side members toward the other side member to deform the side members and peel the latch members apart.

Where the device 105 is used to hold a cable, the vector force direction of a cable pull on the holding members 115 and 120 transmits forces to the latch assembly pulling the holding members 115 and 120 outward as they would normally pivot on their hinges 125. Consequently, the level of force required to release the latch assembly is much larger than the level of force required to latch the latch assembly. The latch assembly is advantageously unobtrusive in that it is located entirely in the plane of the holding members and doesn't represent a significant exposed structure to catch or snag hands or other objects. Another advantage of the latch assembly is that it releases easily with the user's thumb and forefinger where the thumbnail pushes the protrusion toward the base member 110 and the forefinger pulls the holding member resulting in easy hand opening.

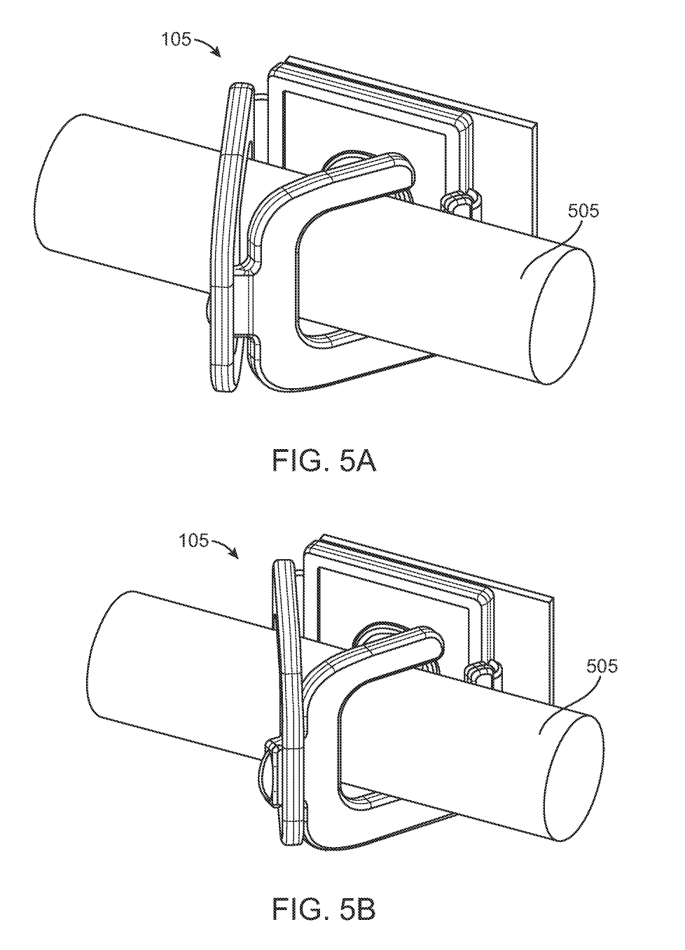

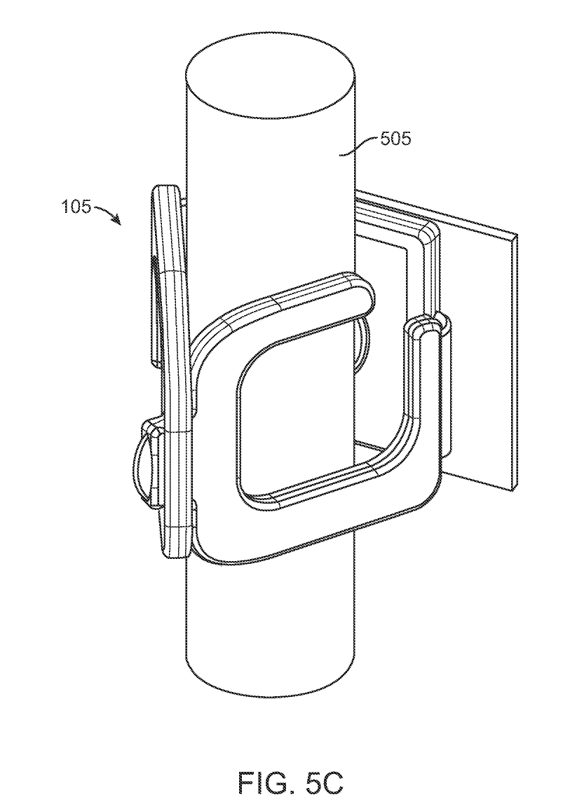

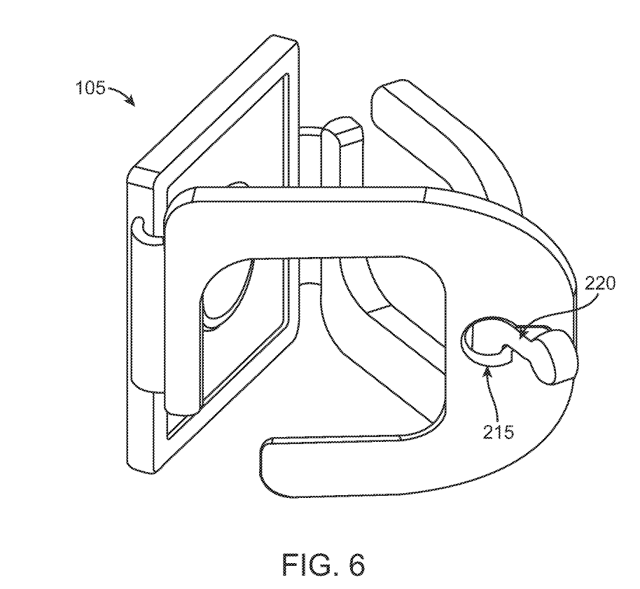

The device 105 can be used to hold a wide variety of items in various manners. For example, FIG. 5A shows the device 105 holding an elongated item 505 in a generally horizontal position such that a longitudinal axis of the item 505 is generally horizontal. The item 505 is positioned through the central openings 135 such that portions of the holding members 115 and/or 120 support the weight of the item 505. Although the item 505 is shown as an elongated rod in FIG. 5A, it should be appreciated that the item 505 can vary. For example, the item 505 can be a toothbrush, cord, cable, pen, pencil, etc. In FIG. 5A, the holding device 105 is in the open state. As shown in FIG. 5B, the holding device 105 can also be transitioned to the closed state such that the holding members 115 and 120 are latched with the item 505 extending through the central openings 135. In another embodiment, shown in FIG. 6, the holding device 105 holds the elongated item 505 in a generally vertical position such that the a longitudinal axis of the item 505 is generally vertical.

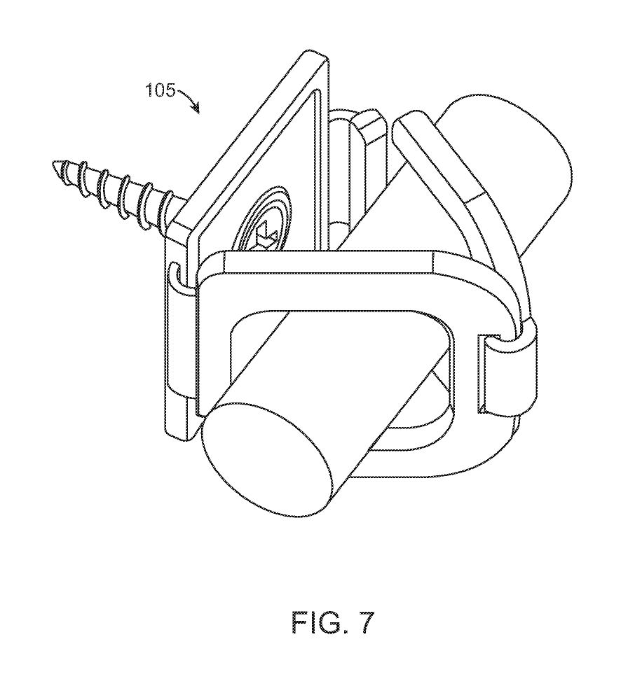

It should be appreciated that the latch assembly 205 can vary in configuration. For example, FIG. 6 shows an embodiment of the holding device 105 wherein the latch assembly is a ball latch configuration. The first latch member 215 is a female member comprised of an opening having a section of reduced width and a section of increased width (relative to the reduced width section) thereby forming a keyhole. The second latch member 220 is a male member comprised of a tab with a widened portion on the tip of the tab. The second latch member 220 can be positioned through the opening of the first latch member 215 and releasably locked therein as shown in FIG. 6. Other configurations for the latch assembly are possible, such as the hook-type assembly shown in FIG. 7.

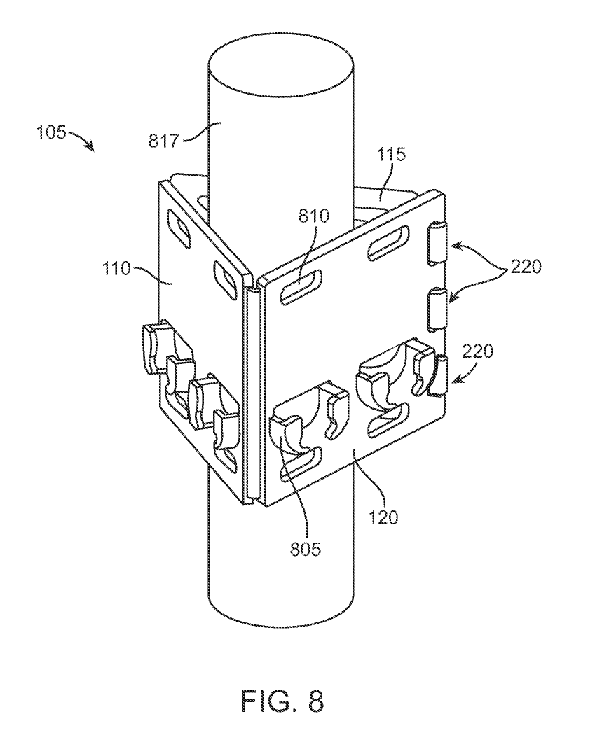

FIG. 8 shows another embodiment of the device 105 wherein the base member 110 and holding members 115 and 120 have flat surfaces that include one or more seats 805 that can support one or more items when the device is used a support on a fixed rod 817. The seats 805 generally comprise U-shaped structures that are sized and shaped to receive any of a variety of items. Each of the members 110, 115, and 120 may also include one or more apertures 810 that serve as a means for securing items to the device 105. The embodiment of FIG. 8 includes multiple latch assemblies 205 for releasably securing the device 105 in the closed state. It should be appreciated that any of the embodiments described herein may include multiple latch assemblies. As shown in FIG. 8, this embodiment of the device 105 can be held by an elongated item, such as a rod or a pole, in a generally horizontal orientation. The embodiment of FIG. 8 can also be held in a variety of orientations other than horizontal.

FIG. 9 shows an embodiment of a holding device 905 that is formed of a plurality of holding members 910 that can be removably secured to one another in a variety of closed configurations. As shown in FIG. 9, each holding members is formed of a generally flat structure having a male latch member 915 that releasably couples to a female latch member 920. The holding members 910 are configured to secured to one another by inserting the male latch member 915 of one holding member 910 into the female latch member 920 of another holding member 910. When at least three holding members 910 are coupled to one another in series, the holding members 910 can be arranged to collectively form a loop of holding members 910 with the male-female latch members securing the holding members 910 to one another in the loop. In this manner, an item 505 can be positioned inside the loop of holding members 910 and secured therein.

FIG. 10 shows the holding device 905 in cross-section cut along the region of the male and female latch members. The male latch member 915 is a protrusion that inserts into a complementary-shaped opening of the female latch member 920. The protrusion is sized and shaped to seat within and against the opening of the female latch member 920 when three of the holding members are coupled in the triangular configuration shown in FIG. 10. When in the triangular configuration, each holding member 910 is oriented at a 60 degree angle relative to an adjacent holding member 910. The triangular configuration is stable and secure and is also configured to absorb forces acting on the structure. In another embodiment, shown in FIG. 11, the holding members 910 can be arranged in a rectangular configuration with each holding member 910 oriented at a 90 degree angle relative to an adjacent holding member 910. Any quantity of holding members 910 can be arranged in series to form closed loops of various sizes and shapes and can utilize multiple latching members on each end of the holding members.

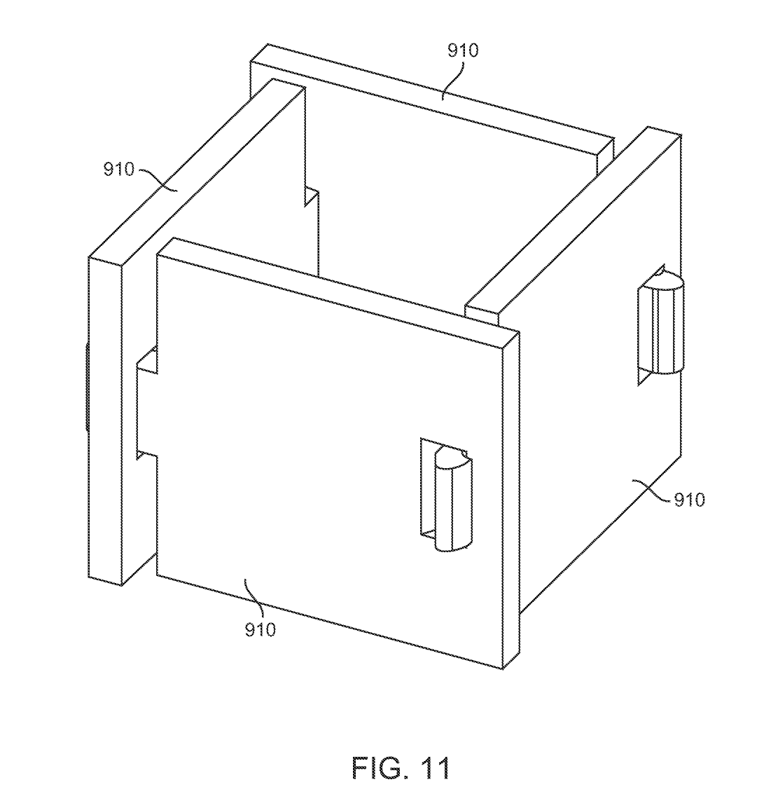

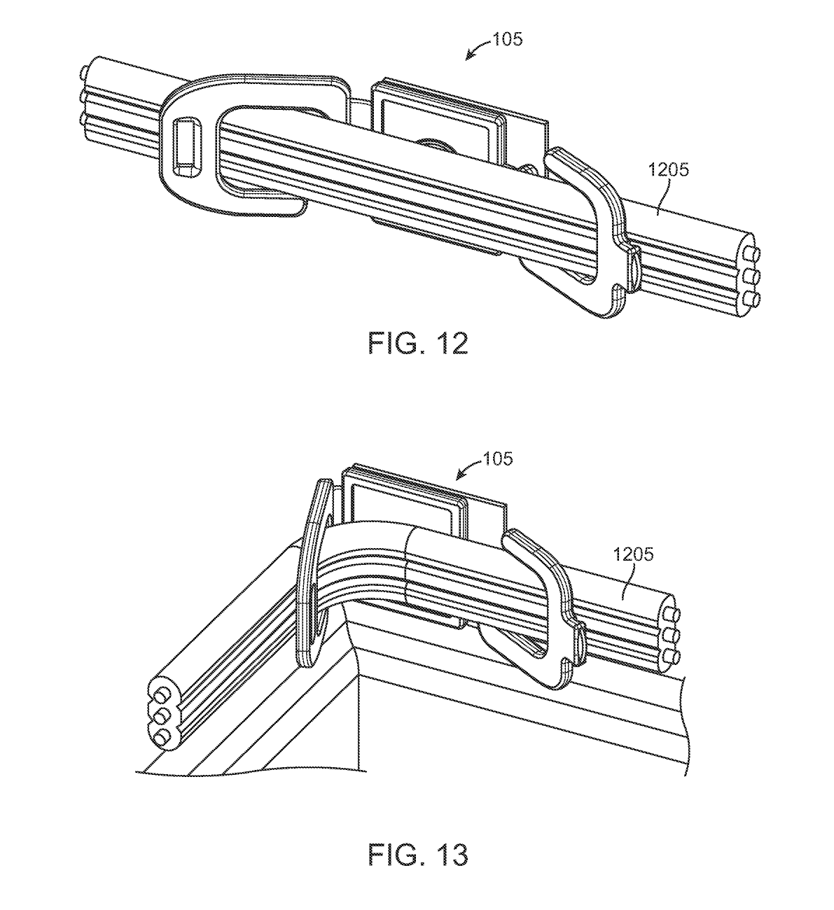

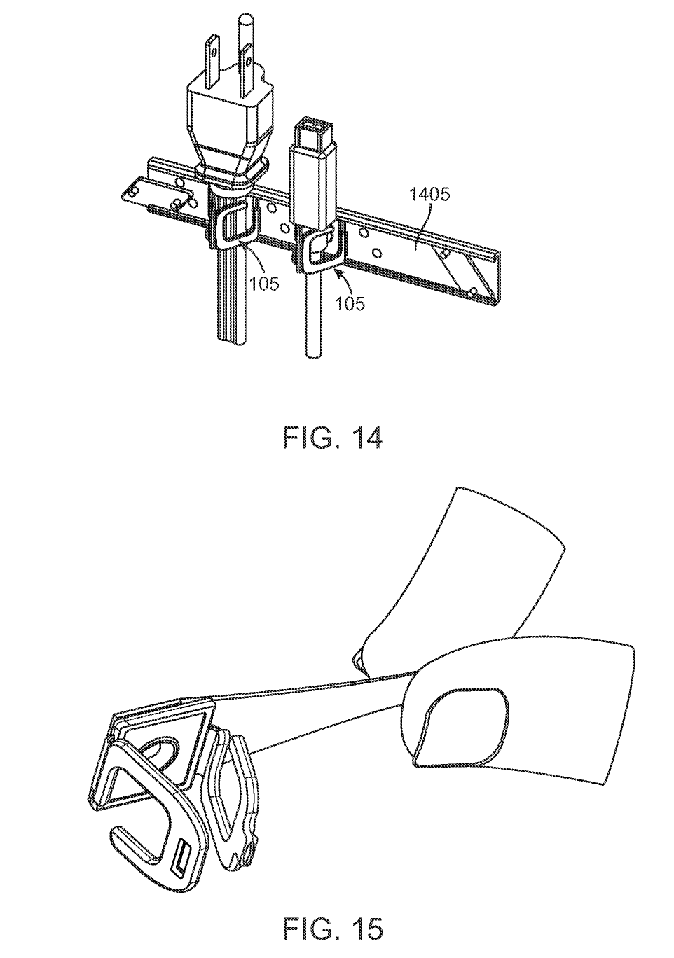

There are now described a variety of examples of the device 105 holding various items in various manners. It should be appreciated that these are simply examples and that the holding device 105 can be used to hold other items not shown. Also, the device 105 can be arranged in various other configurations and geometries. FIG. 12 shows the holding device 105 holding a cable 1205. The two holding members 115 and 120 are splayed outward away from one another to accommodate the orientation of the cable 1205. FIG. 13 shows the holding device 105 holding a cable 1205 with the cable 1205 traversing a corner such that the cable is bent. The two holding members 115 and 120 have been pivoted to an orientation that accommodates the bent cable 1205. FIG. 14 shows multiple holding devices 105 arranged in series to hold the cables or other items at a variety of locations along the length of a track 1405. In another embodiment, shown in FIG. 14, the holding device 105 can be used to hold items such as power cords in generally vertical orientations. The holding device 105 is configured to be mounted on a rail 1405 that mounts onto a wall. In this regard, the holding device 105 can be mounted to the rail 1405 in a variety of manners, such as via a T-slot coupling configuration.

The holding devices described herein may be manufactured of a wide variety of materials. In an embodiment, the holding devices are manufactured of plastic. Other materials include, without limitation, stamped and formed metals with the properties needed for hinging and latching actions. The holding device can be formed using a molding or a casting process or any other process known to those skilled in the art.

In another embodiment, shown in FIG. 15, a releasable adhesive is used as a wire holding device. The releasable adhesive is used to allow temporary or indefinite adhesion for cable holding on a surface. The adhesive is released by pulling an exposed tab of adhesive. The end result is that the adhesive is released without any residue to clean up or any marking or damage to furniture, desks or equipment. The adhesive can be used for both near-permanent desk use and for temporary light load use such as during presentations, conferences & hotel room holding of cables.

As will be apparent to those of skill in the art upon reading this disclosure, each of the individual embodiments described and illustrated herein has discrete components and features which may be readily separated from or combined with the features of any of the other several embodiments without departing from the scope of the subject matter described herein. Any recited method can be carried out in the order of events recited or in any other order which is logically possible.

While this specification contains many specifics, these should not be construed as limitations on the scope of an invention that is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Although embodiments of various methods and devices are described herein in detail with reference to certain versions, it should be appreciated that other versions, embodiments, methods of use, and combinations thereof are also possible. Therefore the spirit and scope of the appended claims should not be limited to the description of the embodiments contained herein.

1. A holding device for holding an item, comprising:
a base member;
a first holding member pivotably attached to a first side of the base member so as to be rotatable relative to the base member;
a second holding member pivotably attached to a second side of the base member opposite the first side so as to be rotatable relative to the base member, wherein the first and second holding members can be rotated toward one another; and
a latch assembly coupled to the first and second holding members, wherein the latch assembly latches as the first and second holding members are rotated toward one another so as to secure the holding device in closed state with the first holding member and second holding member attached to one another, and wherein the base member, first holding member, and second holding member collectively form a triangular shape when the device is in the closed state.

2. A device as in claim 1, wherein the latch assembly comprises:
a male latch member on an edge of the first holding member; and
a female latch member on an edge of the second holding member, wherein the male latch member inserts into the female latch member when the latch assembly is latched.

3. A device as in claim 2, wherein the male latch member comprises a protrusion having a groove, and the female latch member comprises an opening formed by an outer wall, wherein the outer wall of the first latch member sits in the groove when the latch assembly is latched.

4. A device as in claim 1, wherein the base member, first holding member, and second holding member are planar structures.

5. A device as in claim 1, wherein the first and second holding members comprise planar structures and wherein an opening extends through each of the first and second holding members, the opening adapted to receive an item to be held.

6. A device as in claim 5, wherein the opening of the first holding member is completely encircled by the first holding member.

7. A device as in claim 5, wherein the opening of the first holding member is partially encircled by the first holding member.

8. A device as in claim 1, wherein the base member, first holding member, and second holding member collectively form a triangular space when the device is in the closed state, and wherein the item can be held in the triangular space.

9. A device as in claim 1, wherein the device support an item in either a horizontal orientation or a vertical orientation.

10. A holding device, comprising:
a base member;
a first hinge on one side of the base member and a second hinge on an opposite side of the base member;
a holding member on each of the hinges, each of the holding members having a latching member positioned on edge of the holding member opposite the location of the hinge, wherein each holding member rotates about its respective hinge toward the other holding member, and wherein the latching members latch to secure the edges of the holding members to one another such that the base member, first holding member, and second holding member collectively form a triangular shape when the latching members are latched.

11. A device as in claim 10, wherein the latching members include:
a male latch member on an edge of a first holding member; and
a female latch member on an edge of a second holding member, wherein the male latch member inserts into the female latch member when the latch assembly is latched.

12. A device as in claim 11, wherein the male latch member comprises a protrusion having a groove, and the female latch member comprises an opening formed by an outer wall of the first latch member, wherein the outer wall of the first latch member sits in the groove when the latch assembly is latched.

13. A device as in claim 10, wherein the base member and holding members are planar structures.

14. A device as in claim 10, wherein the holding members comprise planar structures and wherein an opening extends through each of the holding members, the opening adapted to receive an item to be held.

15. A device as in claim 14, wherein the opening of at least one holding member is completely encircled by a portion of the holding member.

16. A device as in claim 14, wherein the opening of at least one holding member is partially encircled by the holding member.

17. A device as in claim 10, wherein the base member and holding members collectively form a triangular space when the device is in the closed state, and wherein the item can be held in the triangular space.

18. A device as in claim 10, wherein the device supports an item in either a horizontal orientation or a vertical orientation.
